(19) United States
(12) Patent Application Publication
(10) Pub. No.: US 2025/0254631 A1
(43) Pub. Date: Aug. 7, 2025

(54) MECHANISM FOR UPLINK WAVEFORM SWITCHING

(71) Applicant: T-MOBILE INNOVATIONS LLC, Overland Park, KS (US)

(72) Inventors: Anokhi Shah, Bellevue, WA (US); Mochamad Mirza, Bothell, WA (US)

(21) Appl. No.: 19/187,496

(22) Filed: Apr. 23, 2025

Related U.S. Application Data
(63) Continuation of application No. 17/564,410, filed on Dec. 29, 2021, now Pat. No. 12,317,197.

(51) Int. Cl. H04W 52/24; H04L 27/26; H04W 52/14; H04W 52/36

(52) U.S. Cl. CPC H04W 52/243; H04L 27/2607; H04L 27/2636; H04W 52/146; H04W 52/365

(57) ABSTRACT

Systems, methods, and computer-readable media are described herein to which dynamically provide an optimized mechanism for switching uplink waveforms within a cellular network. An uplink profile generally indicates the number of transmission ports and what uplink waveform is used by a user device to transmit to a base station. Power headroom, channel conditions and signal to interference plus noise are used to modify the uplink profile. These input may be compared to upper and lower threshold values to provide the optimal conditions to switch from a Cyclic Prefix Orthogonal Frequency Division Multiplexing waveform to a Direct Fourier Transform Spread Orthogonal Frequency Division Multiplexing waveform.

### CROSS-REFERENCE TO RELATED APPLICATIONS

This application is a continuation application of U.S. patent application Ser. No. 17/564,410, filed on Dec. 29, 2021, and entitled “Mechanisms for Uplink Waveform Switching,” which is incorporated by reference in its entirety herein.

### SUMMARY

A high-level overview of various aspects of the present disclosure is provided here to introduce a selection of concepts further described below in the detailed description. This summary is not intended to identify key features or essential features of the claimed subject matter, nor is it intended to be used as an aid in isolation to determine the scope of the claimed subject matter.

In brief and at a high level, the present disclosure describes, among other things, systems, methods, and computer-readable media that employ a mechanism for switching uplink waveforms in a cellular network, such that unnecessary switching does not occur and available transmission power is used to capitalize on the benefits of the available uplink transmission waveforms.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF SEVERAL VIEWS OF THE DRAWINGS

Illustrative embodiments of the present disclosure are described in detail below with reference to the attached drawing figures, and wherein:

FIG. 1 depicts an exemplary computing device suitable for use in implementations of aspects described herein.

FIG. 2 depicts an exemplary network environment, in accordance with an embodiment of the present disclosure;

FIG. 3 depicts an exemplary telecommunications environment, in accordance with an embodiment of the present disclosure;

FIG. 4 depicts an exemplary telecommunications environment, in accordance with an embodiment of the present disclosure;

FIG. 5 depicts a flowchart of an exemplary method, in accordance with an embodiment of the present disclosure; and

FIG. 6 depicts a flowchart of an exemplary method, in accordance with an embodiment of the present disclosure.

### DETAILED DESCRIPTION

The subject matter of select embodiments of the present disclosure are described with specificity herein to meet statutory requirements. The detailed description is not intended to define what is regarded as the invention, which is the purpose of the claims. The claimed subject matter might be embodied in other ways to include different steps or combinations of steps similar to the ones described herein, in conjunction with other present or future technologies. Terms should not be interpreted as implying any particular order among or between various steps described herein unless and except when the order of individual steps is explicitly described.

Throughout the description of the present disclosure, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present disclosure. Further, various technical terms are used throughout the detailed description. Definitions of such terms can be found in, for example, Newton's Telecom Dictionary by H. Newton, 31st Edition (2018). These definitions are intended to provide a clear understanding of the ideas disclosed herein but are not intended to limit the scope of the present disclosure. The definitions and terms should be interpreted broadly and liberally to the extent allowed by the meaning of the words offered in the above-cited reference.

Embodiments of the technology may be implemented as, among other things, a method, system, or computer-program product. Accordingly, the embodiments may take the form of a hardware embodiment, or an embodiment combining software and hardware. In one embodiment, the present disclosure takes the form of a computer-program product that includes computer-useable instructions embodied on one or more computer-readable media.

Computer-readable media includes volatile and/or nonvolatile media, removable and non-removable media, and contemplates media readable by a database, a switch, and various other network devices. Network switches, routers, and related components are conventional in nature, as are the means of communicating with the same. By way of non-limiting example, computer-readable media comprises computer storage media and/or communications media. Computer storage media, or machine-readable media, includes media implemented in any method or technology for storing information. Examples of stored information includes computer-useable instructions, data structures, program modules, and other data representations. Computer storage media includes RAM, ROM, EEPROM, flash memory or other memory technology, CD-ROM, digital versatile discs (DVDs), holographic media or other optical disc storage, magnetic cassettes, magnetic tape, magnetic disc storage, and/or other magnetic storage devices. These memory components can store data momentarily, temporarily, or permanently. Computer storage media does not encompass a transitory signal, in embodiments of the present disclosure.

Communications media typically store computer-useable instructions, including data structures and program modules, in a modulated data signal. The term “modulated data signal” refers to a propagated signal that has one or more of its characteristics set or changed to encode information associated therewith. The communications media includes any information-delivery media. By way of non-limiting example, the communications media includes wired media, such as a wired network or a direct-wired connection, and a wireless media, such as acoustic, infrared, radio, microwave, spread-spectrum, and other wireless media technologies. Combinations of the above are included within the scope of the computer-readable media.

At a high level, systems, methods, and computer-readable media described herein implement an uplink waveform switch. Having symmetry between DL and UL transmission schemes provides simplification on the overall design, especially with respect to the wireless backhaul and device-to-device communications. Additionally, the option to use Direct Fourier Transform Spread Orthogonal Frequency Division Multiplexing (DFT-s-OFDM) for uplink transmission is beneficial in coverage-limited scenarios, but is limited to single transmission layer transmission only and has a lower peak-to-average power ratio (PAPR)/cubic metric than Cyclic Prefix Orthogonal Frequency Division Multiplexing CP-OFDM for power reduction purposes. CP-OFDM, in contrast, can support up to four transmission layers, which helps to achieve higher data rates. The low PAPR/cubic metric in DFT-S-OFDM, however, is beneficial for UE power consumption. In practice, a cell site can select between CP-OFDM or DFT-S-OFDM and the UE should be capable to support both in UL. However, the switching between these different waveforms is complex, involving radio resource control (RRC) reconfiguration and needs to have an efficient model to switch between the two waveforms.

To provide an optimized switching between DFT-s-OFDM and CP-OFDM, both uplink channel conditions and available uplink power control is taken into account. By using this information, the UE can take full advantage of the benefits each waveform offers. If the UE runs out of uplink transmission power and SINR is good, it will not trigger switching to the DFT-s-OFDM waveform losing benefits like larger coverage and better cell performance due to PAPR advantages provided by DFTS-OFDM. Additionally if uplink SINR conditions deteriorate and the UE has enough uplink transmission power, it can operate on CP-OFDM waveform to provide benefits from two transmission ports. Also, if uplink SINR deteriorates and there is negligible power headroom, the network switch from the CP-OFDM waveform to the DFT-s-OFDM waveform making the system more robust.

In a first aspect of the present disclosure, a method is provided. The method comprises receiving a radio channel condition indication from a user device. The method further comprises receiving an uplink power headroom indication from the user device. An uplink signal to noise ratio (SINR) is determined based on the radio channel condition. Based on the uplink SINR value it is determined that the uplink SINR has fallen below an uplink SINR threshold and the available uplink transmission power is above a transmission power threshold and instructions are sent to the user device to transmit by way of two transmission ports and to transmit by way of a CP-OFDM waveform.

In a second aspect of the present disclosure, computer-readable media is provided. The computer-readable media includes computer-executable instructions embodied thereon that, when executed, perform a method. In accordance with the method executed by the media comprising receiving a radio channel condition indication from a user device. The method further comprises receiving an uplink power headroom indication from the user device. An uplink signal to noise ratio (SINR) is determined based on the radio channel condition. Based on the uplink SINR value it is determined that the uplink SINR has fallen below an uplink SINR threshold and the available uplink transmission power is above a transmission power threshold and instructions are sent to the user device to transmit by way of two transmission ports and to transmit by way of a CP-OFDM waveform.

In a third aspect of the present disclosure, a system is provided. The system comprises a processor configured to receive an indication that a user device is communicating with a wireless access point using a first uplink profile, the first uplink profile comprising an uplink waveform and an uplink transmission port configuration. A channel condition of the uplink channel is received from the user device. It is determined that the channel condition exceeds a predetermine threshold and instructs are sent to the user device to modify the first uplink profile.

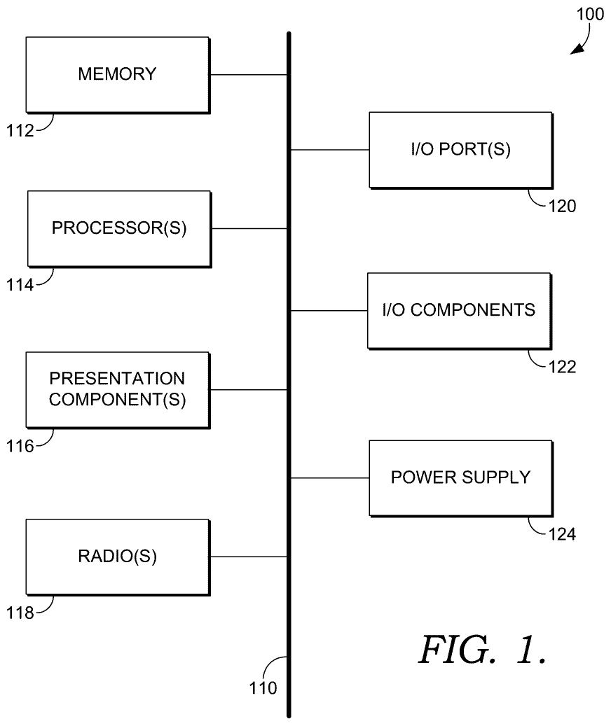

Referring now to FIG. 1, a diagram is depicted of an exemplary computing environment suitable for use in implementations of the present disclosure. In particular, the exemplary computer environment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 104 includes computer-storage media in the form of volatile and/or nonvolatile memory. Memory 104 may be removable, non-removable, or a combination thereof. Exemplary memory includes solid-state memory, hard drives, optical-disc drives, etc. Computing device 100 includes one or more processors 106 that read data from various entities such as bus 102, memory 104, or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

Radio 116 represents a radio that facilitates communication with a wireless telecommunications network. Illustrative wireless telecommunications technologies include CDMA, GPRS, TDMA, GSM, and the like. Radio 116 might additionally or alternatively facilitate other types of wireless communications including Wi-Fi, WiMAX, LTE, or other VolP communications. As can be appreciated, in various embodiments, radio 116 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

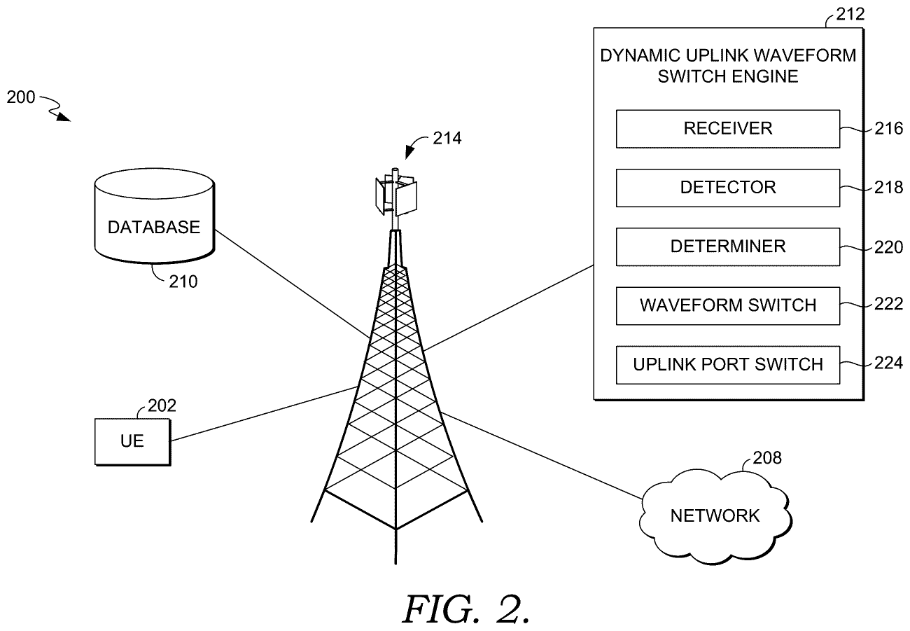

Turning now to FIG. 2, network environment 200 is an exemplary network environment in which implementations of the present disclosure may be employed. Network environment 200 is one example of a suitable network environment and is not intended to suggest any limitation as to the scope of use or functionality of the present disclosure. Neither should the network environment be interpreted as having any dependency or requirement relating to any one or combination of components illustrated.

Network environment 200 includes UE 202 (network environment 200 may contain more UEs), network 208, database 210, dynamic antenna element disablement engine 212, and cell site 214. In the network environment 200, UE 202 may take on a variety of forms, such as a PC, a user device, a smart phone, a smart watch, a laptop computer, a mobile phone, a mobile device, a tablet computer, a wearable computer, a PDA, a server, a CD player, an MP3 player, GPS device, a video player, a handheld communications device, a workstation, a router, an access point, and any combination of these delineated devices, or any other device that communicates via wireless communications with a cell site 214 in order to interact with network 208, which may be a public or a private network.

In some aspects, the UE 202 corresponds to a user device or a computing device. For example, the user device may include a display(s), a power source(s) (e.g., a battery), a data store(s), a speaker(s), memory, a buffer(s), a radio(s), and the like. In some implementations, the UE 202 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, CDMA, or any other type of network.

In some cases, the UE 202 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2 and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Network 208 may be part of a telecommunication network that connects subscribers to their service provider. In aspects, the service provider may be a telecommunications service provider, an internet service provider, or any other similar service provider that provides at least one of voice telecommunications and/or data services to UE 202 and any other UEs. For example, network 208 may be associated with a telecommunications provider that provides services (e.g., LTE) to the UE 202. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1× circuit voice, a 3G network (e.g., CDMA, CDMA 2000, WCDMA, GSM, UMTS), a 4G network (WiMAX, LTE, HSDPA), or a 5G network. The network 208 may also be, in whole or in part, or have characteristics of, a self-optimizing network.

In some implementations, cell site 214 is configured to communicate with the UE 202 that is located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited geographical area. For the purposes of the present disclosure, it may be assumed that it is undesirable and unintended by the network 208 that the cell site 214 provide wireless connectivity to the UE 202 when the UE 202 is geographically situated outside of the cell associated with the cell site 214.

In an exemplary aspect, the cell site 214 comprises a base station that serves at least one sector of the cell associated with the cell site 214 and at least one transmit antenna for propagating a signal from the base station to one or more of the UE 202. In other aspects, the cell site 214 may comprise multiple base stations and/or multiple transmit antennas for each of the one or more base stations, any one or more of which may serve at least a portion of the cell. In some aspects, the cell site 214 may comprise one or more macro cells (providing wireless coverage for users within a large geographic area) or it may be a small cell (providing wireless coverage for users within a small geographic area). For example, macro cells may correspond to a coverage area having a radius of approximately 1-15 miles or more as measured at ground level and extending outward from an antenna at the cell site. In another example, a small cell may correspond to a coverage area having a radius of approximately less than three miles as measured at ground level and extending outward from an antenna at the cell site.

As shown, cell site 214 is in communication with the dynamic uplink waveform switch engine 212, which comprises a receiver 216, a detector 218, a determiner 220, waveform switch 222, and an uplink transmission port switch 224. The dynamic uplink waveform switch engine 212 may connect UE 202 and other UEs to frequency bands within range of the UE 202 or other UEs for access to network 208. The dynamic uplink waveform switch engine may switch the uplink waveform that UE 202 is using to transmit over the network 208. The dynamic uplink waveform switch engine 212 may communicate with the database 210 for storing and retrieving data. The dynamic uplink waveform switch engine 212 may also dynamically control the number of transmission ports that UE 202 is using.

For example, the receiver 216 may retrieve data from the UE 202, the network 208, the database 210, and the cell site 214. In some embodiments, the receiver 216 may receive requests from UEs for access to a particular frequency band. Further, data the receiver 216 may access information which includes, but is not limited to, location information of the UE 202, channel quality information, channel condition information, uplink waveform information, and power headroom information. Location information may comprise GPS or other satellite location services, terrestrial triangulation, an access point location, or any other means of obtaining coarse or fine location information. The location information may indicate geographic location(s) of one or more of a user device, an antenna, a cell tower, a cell site, and/or a coverage area of a cell site, for example. Channel quality information or channel condition information may indicate the quality of communications between one or more user devices and a particular cell site. For example, channel quality information may quantify how communications are traveling over a particular communication channel quality, thus indicating when communications performance is negatively impacted or impaired. As such, channel quality information may indicate a realized uplink and/or downlink transmission data rate of a cell site and/or each of one or more user devices communicating with the cell site, observed signal to interference plus noise ratio (SINR) and/or signal strength at the user device(s), or throughput of the connection between the cell site and the user device(s).

Uplink waveform information may indicate a waveform that UE 202 is using to broadcast or transmit. For example, UE 202 may be operating by transmitting by way of Orthogonal Frequency Division Multiplexing using (OFDM). As an example waveform a DFT-s-OFDM may be used by UE 202. Additionally, in other embodiments, a CP-OFDM may be used. The UE 202 may also transmit using other waveforms not mentioned in this disclosure but would be suitable waveforms for purposes of this disclosure.

Power headroom information may indicate the power headroom available in UE 202. For example, the power headroom information may indicate the difference between the maximum transmit power and the calculated transmit power for the UE 202. Power headroom values for the UE 202 indicate the difference between the maximum UE transmit power and current or nominal UE transmit power. A power headroom value that is a positive value may indicate that there is a surplus or an available transmit power for UE 202. A power headroom value that is a negative value may indicate that there is a deficit of transmit power for UE 202. The power headroom information may be received by way of either a periodic report or when the downlink path loss changes by a specific amount. The amount of power headroom or available transmit power may indicate that there is enough available transmit power to transmit by way of more transmit ports than currently being used. For example, an excess available transmit power may be used to operate two or more transmit ports rather than one.

Location, channel quality information, and power headroom information may take into account the UE's capability, such as the number of antennas of the user device and the type of receiver used by the user device for detection. The receiver 216 may also be configured to receive information from cell sites other than cell site 214 or other processors and/or servers.

Each sector corresponds to a radiation pattern of a corresponding antenna at the cell site. The shape, size, and dimension(s) of the service coverage area of the cell site are, generally, determined by an antenna's specific radiation pattern, as well as a direction, electrical tilt, mechanical tilt, installation height above the ground or surrounding geographic area, technical operating specifications, materials, obstructions (i.e., buildings, mountains, or other elevations), and power supplied to each of the first, second, and third antennas of the cell site, for example. The first, second, and third antennas wirelessly receive and transmit RF transmissions to and from, for example, user equipment, other antennas, other cell sites, base stations, and/or satellites, in order to facilitate communications between such devices, though not shown in FIG. 2 for clarity. In an embodiment, the first, second, and third antennas of the cell site capture two-way communications between the network and UE 202 that are within a geographic area corresponding to the service coverage area of the cell site.

Turning to detector 218, the detector 218 may detect UEs within a range, frequency bands, sector power ratios (SPRs) of frequency bands, SINRs, and loading factors (e.g., loading volume) corresponding to frequency bands, etc. Loading factors may change depending upon the day and time of day (e.g., world events such as natural disasters, terror attacks, pandemics, or religious holidays may prompt surges of UE traffic to or from specific locations), and may be stored in the database 210. Loading factors may include cell site 214 heat signature information, cell site 214 component performance information, channel quality information, or processor load measurements. Factors affecting the heat signature information of the cell site 214 include component model, component type, manufacturer, age of a component, wear and tear due to environmental factors, etc. Further, loading factors may also include an amount of current, backhaul traffic, or an anticipated current or backhaul traffic. Additionally, factors affecting loading volume may include a quantity of users connected to a frequency band or antenna properties at a time of receiving communication parameters from UEs connected to the frequency band. Other factors affecting loading volume may also include a capability of the frequency band and data received from the quantity of users connected to the frequency band. The data received from the quantity of users may comprise a rate at which UEs are connected to and disconnected from the frequency band.

Detector 218 may also detect wireless communication operating using a particular transmission waveform. For example, the detector 218 may detect that a waveform being transmitted by UE 202 is a DFT-s-OFDM. Additionally, the detector 218 may detect a waveform being transmitted by UE 202 is a CP-OFDM. Detector 218 may also detect the available transmission power from the UE 202. For example, detector 218 may detect that the UE 202 has enough available transmission power to witch the UE from transmitting from a single transmission port to transmitting using two or more transmission ports.

Turning to determiner 220, the determiner 220 may determine the SINR from the channel quality information related to the UE 202. For example, information about the channel quality or the radio channel condition (CQI) may be used to determine the SINR for the UE 202 transmitting to a base station. Alternatively, the base station may measure or calculate the SINR independent of any CQI. Once the measured SINR is identified or measured, the determiner may then determine if the SINR from the UE 202 exceeds a predetermined threshold. As an example, the determiner 220 may measure a SINR value which exceeds a threshold value. This threshold value may be set by an operator. This threshold value would be used to indicate that the transmission quality has decreased below an acceptable level. Once the determiner 220 determines that the SINR threshold value, action may be taken to reduce the SINR to an acceptable level or below the threshold value. Additionally, the determiner 220 may determine that the SINR value has not exceeded a threshold value and thus no action need be taken.

Once the determiner 220 determines that the SINR value has exceeded a threshold value, the dynamic uplink waveform switch engine 212 must determine what waveform the UE 202 is using to transmit. In an exemplary embodiment determiner 220 determines that UE 202 is transmitting using the waveform CP-OFDM. In another embodiment is transmitting using a DFT-S-OFDM waveform. Additionally, determiner 220 determines what transmission ports the UE 202 is using to transmit. In one embodiment, determiner 220 determines that UE 202 is transmitting using 2 antenna ports. In another embodiment, determiner 220 determines that UE 202 is transmitting using 1 antenna port. The number of ports may be determined to be more than 2 in some embodiments. Determiner 220 may also determine that the power headroom received from the UE 202 exceeds a threshold value. The threshold value is input to identify if the available power is enough to support transmitting using additional antenna ports. For instance, if the power headroom indicates that there is some available power, determiner 220 must determine if that available power is enough to switch from a single antenna port to multiple antenna ports.

Turning to waveform switch 222, the waveform switch is designed to switch the transmission waveform of the UE 202 based on the SINR and the power headroom threshold determinations. In one embodiment, the waveform switch 222 will switch the waveform of the UE 202 from CP-OFDM to DFT-s-OFDM based on the determination that the SINR value has exceeded a threshold value. In one another the waveform switch 222 will switch the waveform of the UE 202 from CP-OFDM to DFT-s-OFDM based on the determination that the SINR value has exceeded a threshold value and the number of transmission uplink ports being used is two or one. Switching from CP-OFDM in this case requires uplink port switch 224 to switch the number of uplink port switches for UE 202 from two to one, or a higher number to a lower number of uplink ports. Additionally, if the power headroom indicates that there is not enough transmission power, a switch of waveforms will not be triggered on that alone, but requires a SINR value above a threshold value as well.

In another embodiment, waveform switch 222 will switch the waveform of the UE 202 from CP-OFDM to DFT-s-OFDM based on the determination that the SINR value has exceeded a threshold value and that the power headroom is not sufficient to increase the number of uplink transmission ports from 1 to 2. For example, if the SINR conditions deteriorate such that the value exceeds a threshold value and there is not enough power to increase transmission from one uplink port to two uplink ports, the waveform switch will instruct the UE 202 to transmit using the DFT-s-OFDM waveform instead of the CP-OFDM waveform.

Turning to uplink port switch 224, uplink port switch 224 may be used to increase or decrease the number of uplink ports being used to transmit on the UE 202. For example, as explained above, if the uplink port switch 224 will switch the number of uplink ports from two to one in the situation where the SINR value has exceeded a threshold and the number of ports being used is two. Once the uplink port switch 224 changes the number of uplink ports from two to one, the waveform switch 222 may then switch the waveform from CP-OFDM to DFT-s-OFDM.

Additionally, the uplink port switch 224 may increase the number of uplink ports being used by UE 202 from one to two. For example, if the SINR value has been determined to exceed a threshold value and the power headroom exceeds a threshold value, the uplink port switch 224 will switch the number of uplink ports being used by UE 202 from one to two. Thus not requiring the waveform to be switched because there is enough power to transmit using more than one uplink port.

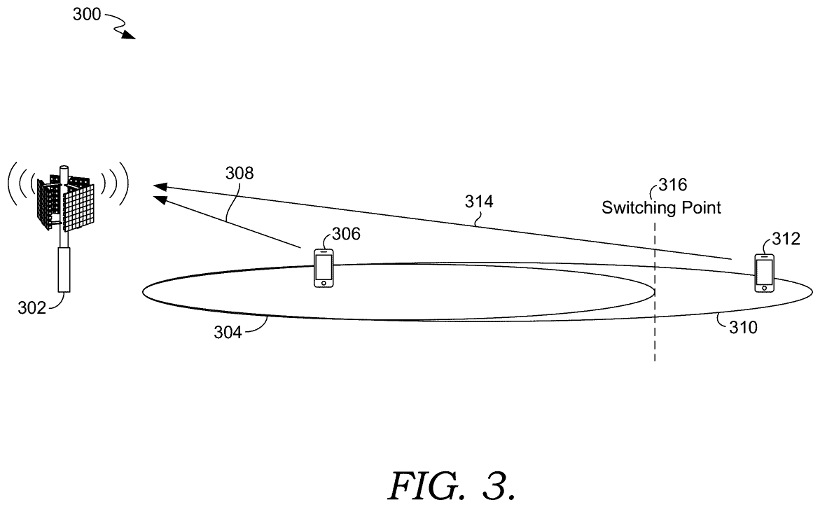

Turning now to FIG. 3, exemplary environment 300 comprises cell site 302, a first geographical area 304, UE 306, a first uplink waveform 308, a second geographical area 310, a second uplink waveform and a switching point 316. As can be seen in the aspect depicted in FIG. 3, the cell site 302 includes the one or more antennas. In aspects, the one or more antennas may be dipole antennas, having a length, for example, of ¼, ½, 1, or 1½ wavelength. In aspects, cell site 302 may be an active antenna array, FD-MIMO, massive MIMO, 3G, 4G, 5G, and/or 802.11. While we refer to dipole antennas herein, in other aspects, the one or more antennas may be monopole, loop, parabolic, traveling-wave, aperture, yagi-uda, conical spiral, helical, conical, radomes, horn, and/or apertures, or any combination thereof. It is noted that adjusting one or more individual power supplies to the one or more antennas of the cell site 302 may be applicable to an antenna array comprising any type of antenna targeting any portion of the RF spectrum (though any lower than VHF may be size prohibitive). In one aspect, the one or more antennas may be configured to communicate in the UHF and/or SHF spectrum, for example, in the range of 1.3 GHz-30 GHz.

By way of a non-limiting example, the first antenna array may comprise 64 antenna elements arranged in an 8×8 structure. In other aspects, the first antenna array 303 may comprise antenna elements arranged in an 8×4, 4×8, or 4×4 configuration. Each antenna element of the first antenna array 303 comprises a dedicated power supply having a certain phase and amplitude to a respective antenna element. In an aspect, the power supply comprises a power amplifier. In an aspect not depicted in the figures, the base station may further comprise a processor. The processor may be one or more of processors, servers, computer processing components, or the like. In some aspects, the processor may be communicatively coupled to each node and/or to each antenna of each node.

In certain aspects, the first antenna array may communicate or is capable of communicating with devices, using a 5G wireless communication protocol. While in this example 5G is mentioned as a wireless communication protocol, it should be understood that any wireless communication protocol standard may be utilized for example, 3G, 4G, LTE, 5G, 802.11, or any other operator-elected wireless communication protocol standard. In the aspect depicted in FIG. 3, the first antenna array can include 64 antenna elements each with a distinct direction which may be known, and where each antenna element is capable of communicating with one or more devices, e.g., using one or more specific beams, each identifiable as a beam index, as referred to herein, in aspects. In the same or alternative aspects, a device may communicate with more than one antenna element of the first antenna array. In aspects, using the methods and systems disclosed herein with a high-density antenna array, such as the first antenna array, and using a 5G wireless communication protocol as an example, can facilitate the strategic assignment of beam indices and/or allotment of beam indices tailored for a specific purpose or environment

Some portions of FIG. 3 illustrate the areas where DFT-s-OFDM and CP-OFDM typically are used. When the UE 306 is close to the cell site 302 in the first geographical area 304, channel conditions are likely to be good so that CP-OFDM and a single transmission layer or multiple transmission layers can be used for uplink transmission. On the other hand, when the second UE 312 is located far away from the cell site 302 in the second geographical area 310, channel conditions are likely to be poor in comparison to the first geographical area 304 so that DFT-S-OFDM and a single transmission layer is used for uplink transmission.

In some embodiments, the first UE 306 will be within the first geographical area 304. While within the first geographical area 304, the SINR value for the first UE 306 may be indicated as below a threshold value. A low SINR value would indicate that the channel quality is good and that no action is needed thus, the first waveform 308 for the first UE 306 will be maintained. In some embodiments, the first waveform is a CP-OFDM waveform. However, there may be instances where the SINR value does exceed the threshold value while the UE 306 with within the first geographical area. In this embodiment, the power headroom may be found to exceed a threshold value and a waveform switch would not be required but the number of uplink ports would be increased from one to two.

In another embodiment, while the second UE 312 is within the second geographical area 310, the SINR value may exceed a threshold value and the power headroom may not exceed a threshold value. The UE 312 will then switch to transmit using the second waveform 314 rather than the first waveform 308. In some embodiments, the second waveform 314 is a DFT-s-OFDM waveform. A critical point exists at the switching point 316 where the values of SINR exceed a threshold value and power headroom values don't exceed a threshold value. The switching point 316 is where a UE will switch from the first waveform 308 to the second waveform 314. This location may be where a UE has exceeded a distance for the UE to be able to transmit low SINR transmissions using two uplink ports and the switch between CP-OFDM and DFT-s-OFDM may, in addition to channel conditions and power headroom, be based on location.

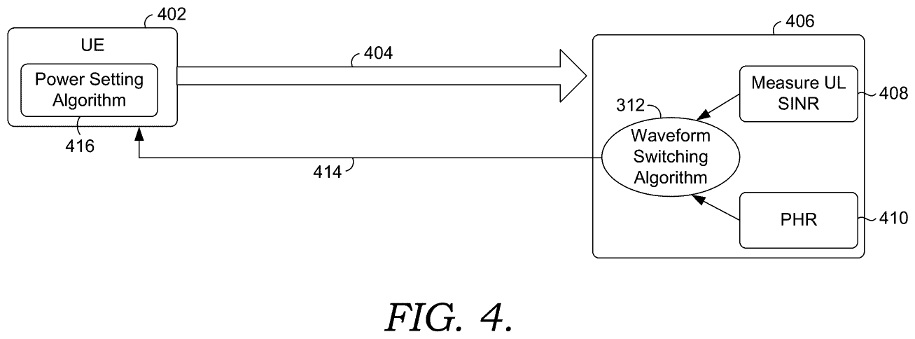

Turning now to FIG. 4, exemplary environment comprises UE 402 and a cell site 406. UE 402 operates under conditions as described above. As such, communication between the UE 402 and the cell site 406 provide information such as channel quality and power headroom. For example, UE 402 communicates through step 404 channel quality information and a power headroom report. The power headroom report may indicate the power headroom measured either periodically or in response to the channel conditions deteriorating. Upon receiving the channel quality information and the power headroom report, cell site 406 may use that information to compute or measure SINR 408. Cell site 406 may also independently measure SINR based on uplink transmission to the cell site 406. The Power headroom report 410 provides, among other thing, a power headroom value for UE 402.

Waveform switching algorithm 412 uses the SINR values and power headroom values to decide if the channel conditions have deteriorated and if a waveform switch is required. This algorithm uses decision logic as described above. For example, if the SINR value exceeds a threshold and the power headroom value does as well, a waveform switch is not completed but the UE 402 is instructed to increase the number of uplink ports from one to two. In another example, if the SINR value exceeds a threshold value and the power headroom does not exceed a threshold value, the waveform algorithm provides instructions 414 to the UE 402 to switch transmission waveforms from a CP-OFDM waveform to a DFT-s-OFDM waveform. Instructions 414 may be communicated using radio resource control (RRC) protocols from the cell site 406 to the UE 402. The RRC protocol may indicate that the connection configuration of the UE 402 needs to be reconfigured such that the transmission waveforms are changed.

Additionally, the RRC protocol communication or the instructions 414 may provide instructions to the power setting algorithm 416. The power setting algorithm 416 receives input and provides instructions to change the number of transmission uplink ports being used. For example, the cell site 406 may provide information that the SINR value has exceeded a threshold value and the power headroom has exceeded a threshold value. When the power setting algorithm 416 receives this information it provides instructions to increase the number of transmission uplink ports from one to two.

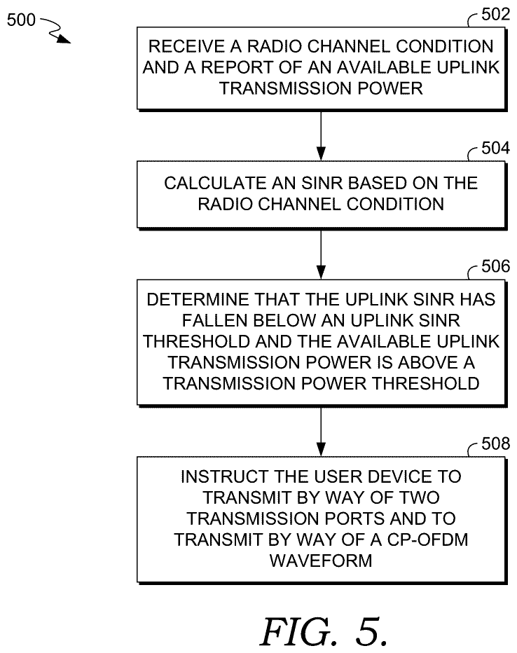

Referring to FIG. 5, a flowchart of an exemplary method 500 is illustrated for implementing an uplink wave form. Initially at block 502, a radio channel condition is received from a UE. Additionally, at block 502, the power headroom indication is received. At block 504, the SINR of the UE is calculated based on the received radio channel condition. At block 506 it is determined that the uplink SINR has fallen below an uplink SINR threshold and the available uplink transmission power is above a transmission power threshold. At block 508, the UE is instructed to transmit by way of two transmission ports and by way of CP-OFDM waveform.

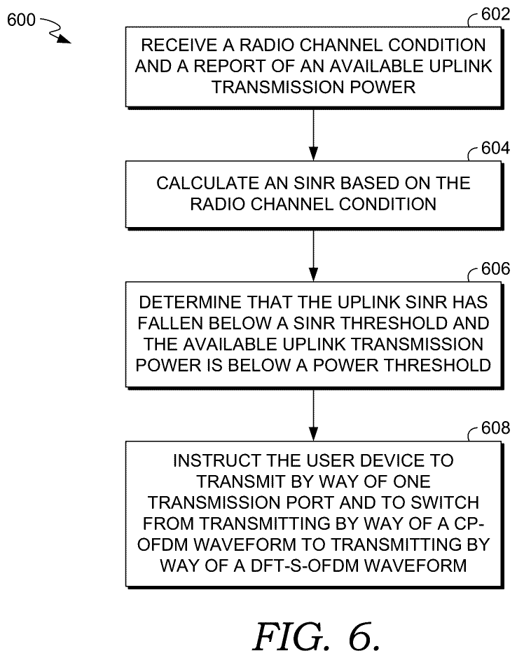

Referring to FIG. 6, a flowchart of an exemplary method 600 is illustrated for implementing an uplink wave form. Initially at block 602, a radio channel condition is received from a UE. Additionally, at block 602, the power headroom indication is received. At block 604, the SINR of the UE is calculated based on the received radio channel condition. At block 606 it is determined that the uplink SINR has fallen below a SINR threshold and the available uplink transmission power is below a power threshold. At block 608, the UE is instructed to transmit by way of one transmission port and to switch from transmitting by way of a CP-OFDM waveform to transmitting by way of a DFT-S-OFDM waveform.

Many different arrangements of the various components depicted, as well as components not shown, are possible without departing from the scope of the claims below. Embodiments of this technology have been described with the intent to be illustrative rather than be restrictive. Alternative embodiments will become apparent to readers of the present disclosure. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A method for implementing an uplink waveform switching within a threshold distance at a user device (UE), the method comprising:
communicating an uplink power headroom indication of an uplink power headroom;
communicating a radio channel condition indication; and
receiving instructions to transmit by way of two transmission ports and to transmit by way of a first waveform;
wherein the instructions are based on a network provider determining that an uplink signal to interference and noise ratio (SINR) exceeds an uplink SINR threshold and that the uplink power headroom is greater than a transmission power threshold, and wherein the threshold distance is a distance where the UE is able to transmit low SINR transmissions using two or more transmission ports.

2. The method of claim 1, wherein the uplink SINR is calculated based on the communicated radio channel condition indication.

3. The method of claim 1, wherein the transmission power threshold indicates that there is enough power to transmit over the two or more transmission ports.

4. The method of claim 1, wherein the instructions are received by way of a radio resource control reconfiguration.

5. The method of claim 1, wherein the first waveform is a cyclic prefix Orthogonal Frequency Division Multiplexing waveform.

6. A method for implementing an uplink waveform switching outside a threshold distance of a user device (UE), the method comprising:
communicating an uplink power headroom indication of an uplink power headroom;
communicating a radio channel condition indication; and
receiving instructions to transmit by way of one transmission port and to switch from transmitting by way of a first waveform to transmitting by way of a second waveform,
wherein the instructions are based on a network provider determining that an uplink signal to interference and noise ratio (SINR) is below an uplink SINR threshold and that an available uplink transmission power headroom is below a transmission power threshold, and wherein the threshold distance is a distance where the UE is able to transmit low SINR transmissions using two or more transmission ports.

7. The method of claim 6, wherein the uplink SINR is calculated based on the communicated radio channel condition indication.

8. The method of claim 6, wherein the transmission power threshold indicates that there is enough power to transmit over the two or more transmission ports.

9. The method of claim 6, wherein the instructions are received by way of a radio resource control reconfiguration.

10. The method of claim 6, wherein the first waveform is a cyclic prefix Orthogonal Frequency Division Multiplexing waveform.

11. The method of claim 6, wherein the second waveform is a Direct Fourier Transform Spread Orthogonal Frequency Division Multiplexing waveform.

12. A system for implementing an uplink waveform switch outside a threshold distance of a user device (UE) comprising:
one or more computer components configured to perform a method comprising:
communicating an uplink power headroom indication of an uplink power headroom;
communicating a radio channel condition indication;
receiving instructions to transmit by way of two transmission ports and to transmit by way of a first waveform, wherein the instructions are based on a network provider determining that an uplink signal to interference and noise ratio (SINR) exceeds an uplink SINR threshold and that an uplink transmission power headroom is greater than a transmission power threshold; or
receiving instructions to transmit by way of one transmission port and to switch from transmitting by way of the first waveform to transmitting by way of a second waveform, wherein the instructions are based on the network provider determining that the SINR is below the uplink transmission power headroom is below the transmission power threshold,
wherein the threshold distance is a distance where a user device (UE) is able to transmit low SINR transmissions using the two or more transmission ports.

13. The system of claim 12, wherein the uplink SINR is calculated based on the communicated radio channel condition indication.

14. The system of claim 12, wherein the transmission power threshold indicates that there is enough power to transmit over the two or more transmission ports.

15. The system of claim 12, wherein the instructions are received by way of a radio resource control reconfiguration.

16. The system of claim 12, wherein the first waveform is a cyclic prefix Orthogonal Frequency Division Multiplexing waveform.

17. The system of claim 12, wherein the second waveform is a Direct Fourier Transform Spread Orthogonal Frequency Division Multiplexing waveform.
